(19) United States
(12) Patent Application Publication
(10) Pub. No.: US 2022/0112136 A1
(43) Pub. Date: Apr. 14, 2022

(54) AGRICULTURAL COMPOSITION CONTAINING SI CLAY AND A BASE

(71) Applicant: HELENA AGRI-ENTERPRISES, LLC, Collierville, TN (US)

(72) Inventor: Chris ALBRIGHT, Jensen Beach, FL (US)

(21) Appl. No.: 17/501,080

(22) Filed: Oct. 14, 2021

Related U.S. Application Data
(60) Provisional application No. 63/091,522, filed on Oct. 14, 2020.

(51) Int. Cl. C05D 9/02; C05G 5/12; C05G 5/10; C05D 5/00; C05D 1/00

(52) U.S. Cl. CPC C05D 9/02; C05G 5/12; C05D 1/00; C05D 5/00; C05G 5/10

(57) ABSTRACT

The invention relates to a process of treating a plant which applies an agricultural composition which contains Si clay granules or powders and a base wherein the composition is applied in an amount from about 150 pounds to about 4,000 pounds per acre. The invention also relates to an agricultural composition containing Si clay granules or powders and a base wherein the composition can be applied in an amount from about 150 pounds to about 4,000 pounds per acre.

### CROSS-REFERENCE TO RELATED APPLICATIONS

This application claims benefit of U.S. Provisional Application No. 63/091,522, filed Oct. 14, 2020, which is incorporated herein by reference in its entirety.

### BACKGROUND OF THE INVENTION

Si amendments may increase cane and sugar yields as much as 25% and may support more successful ratoon crops.

Adding a soil amendment, also called a soil conditioner, helps improve plant growth and health. The type of amendment or amendments added depends on the current soil composition, the climate, and the type of plant. Some of the various amendments include:

1. Lime (makes soil less acidic)
2. Fertilizers for plant nutrients (i e manure, peat, or compost)
3. Materials for water retention (i.e. clay, shredded bark, or vermiculite)
4. Gypsum (releases nutrients and improves structure)
5. Clay (allows water to reach the plant root).

Various elements, which are normally drawn from the soil, are known to be essential to plant nutrition. These elements include: nitrogen (N), phosphorus (P), potassium (K), sulfur (S), calcium (Ca), magnesium (Mg), iron (Fe), manganese (Mn), copper (Cu), cobalt (Co), zinc (Zn), boron (B), nickel (Ni), molybdenum (Mo), and chlorine (Cl). Of these elements, nitrogen, phosphorus, potassium, sulfur, calcium, and magnesium are needed by plants in relatively large quantities and are therefore called macronutrients. The remaining members of the group (iron, manganese, copper, cobalt, zinc, boron, nickel, molybdenum, and chlorine) are known as micronutrients since they are required in very small amounts for plant growth.

Supplying a plant's major nutrient needs (nitrogen, phosphorus, potassium-N—P—K) is most effective and economical via soil application. However, foliar application has proven to be an excellent method of supplying plant requirements for secondary macronutrients (sulfur, calcium, magnesium) and micronutrients (carbon (C), hydrogen (H), and oxygen (O), nitrogen (N), phosphorus (P) and potassium (K), while supplementing N—P—K needs for short and/or critical growth stage periods. Additionally, the so called micronutrients, also commonly provided by mineral fertilizers are: boron (B), chlorine (Cl), copper (Cu), iron (Fe), manganese (Mn), zinc (Zn) and molybdenum (Mo). Foliar application refers to the application of plant nutrients to above-ground plant parts. Foliar fertilization programs prolong the fertilizing application period, providing a continuous supply of nutrients when crop demand is at a maximum, and can be an economical way to boost yield.

In fertilization programs, sulfate metal salts (e.g., zinc sulfate, manganese sulfate, and copper sulfate) are an economical source affording both sulfur and micronutrients.

Humectants have also been used to help retain water within the soil and plant tissue. These features make the incorporation of a humectant into a foliar fertilizer potentially beneficial to the needs of the plant.

Si applications with sugarcane have been discussed in detail in the publication, Savant, N. K, Korndorfer, G. H., Datnoff, L. E. and Snyder, G. H. 1999. Silicon Nutrition and Sugarcane Production: A Review, J. Plant Nutr. 22 (12):1853-1903 (Savant) which is incorporated by reference. Savant disclose the using silicate slag and calcium silicate slag as the source of Si for sugarcane.

The Everglades Research and Education Center, (University of Florida), has data that suggests that when soils test low for acetic acid extractable Si (less than 10 ppm in the soil extract), a 3 ton/Acre application of Ca-silicate slag will likely support favorable yield improvements over a three-crop cycle. A three-crop cycle is where the same crop is grown for three years. The Si source is generally broadcast applied and disked into the soil prior to planting.

Leaf Si analysis is very useful in combination with soil test Si values in determining the need for calcium silicate application.

Deficiency symptoms: Si deficiency is characterized by minute, circular white leaf spots (freckles). The freckling is more severe on older leaves. Older leaves may senesce prematurely, and the stools exhibit poor tillering and ratooning characteristics.

The philosophy that drives this is one identified by the American Society of Agronomists and is called the 4R's.
Right product
Right rate
Right timing
Right place

Current practices of adding silicon has been reduced to a soil amendment process and only applied prior to planting, (sugarcane is planted once in 3 years and yields three crops, one per year). This application requires 1-3 tons per acre every 3-4 years and in 2020 costs up to $250 per acre. Not only is this an expensive input, but one that runs contrary to the concept of the 4R's.

Agsorb® is a clay-based granules from Oil-Dri Corporation of America (Oil-Dri), has been used in the fertilizer industry as a fertilizer blend conditioning agent. Fertilizer salts by virtue of their properties absorb moisture and this phenomenon is exasperated when certain fertilizer materials are blended together and so the need for a conditioning agent. Agsorb® can mitigate the impact of excessive moisture in a blend, preserving manageable application properties of the blend for the grower. Agsorb® is granules that include Montmorillonite from Ripley Miss. or from Mounds Ill., Attapulgite from Ochlocknee Ga., and Hysrous Aluminosilicate from Taft, Calif. Below is the technical sheets for the above material from Oil-Dri shown in Tables 1 (granules) and Table 2 (powders).

TABLE 1
Granules

| | | | | | Liquid | Bulk |
|---|---|---|---|---|---|---|
| | | | Size Guide | Uniformity | Holding | Density |
| Production | | | Number Ps | Index Ps | Capacity | Lbs/Ft³ |
| Location & Mineral | Product | Process | 006.01.01 | 006.01.01 | Wt % E1521-93 | E1521-91 |
| Classification | Name | Options | (GSA) | (GSA) | (ASTM) | (ASTM) |
| Ripley, MS | 30/60 | RVM | 40 | 50 | 31 | 37 |
| MONTMORILLONITE | 24/48 | LVM | 55 | 45 | 33 | 36 |
| | 16/30 | LVM | 85 | 50 | 33 | 36 |
| | 8/16 | LVM | 170 | 55 | 33 | 35 |
| | 5/20 | LVM | 215 | 25 | 33 | 35 |
| | 40/100 | LVM | ALPINE SIEVE PS | | 33 | 37.5 |
| | | | 006.01.01 (GSA) | | | |
| | | | 90% −325/+120 MESH | | | |
| Ochlocknee, GA | 24/48 | LVM | 55 | 40 | 35 | 32 |
| ATTAPULGITE | 16/30 | RVM | 85 | 50 | 32 | 33 |
| | 16/30 | LVM | 85 | 50 | 35 | 32 |
| | 12/24 | LVM | 110 | 60 | 35 | 31 |
| | 8/16 | LVM | 170 | 55 | 35 | 31 |
| | 5/20 | LVM | 215 | 25 | 35 | 32 |
| Taft, CA | 24/48 | RVM | 55 | 40 | 27 | 39 |
| HYDROUS | 16/30 | RVM | 85 | 50 | 27 | 38 |
| ALUMINOSILICATE | 5/20 | RVM | 215 | 25 | 27 | 40 |

| | | Moisture | Particle | Attrition | |
|---|---|---|---|---|---|
| Production | pH | Content Wt % | Count | % Resistance | |
| Location & Mineral | In 001.01.01 | D2216-80 | E1520-93 | P-A 1056 B | Available |
| Classification | (ODC) | (ODC) | (ASTM) | (GSA) | Colors |
| Ripley, MS | 5 | 7 | 10.1 | 75-85 | GRAY |
| MONTMORILLONITE | 5 | <3 | 8.6 | 85-90 | GRAY OR RED |
| | 5 | <3 | 1.6 | 85-90 | GRAY |
| | 5 | <3 | 0.4 | 85-90 | GRAY OR RED |
| | 5 | <3 | 0.5 | 85-90 | GRAY OR RED |
| | 5 | 1.5 | 18 | 85-90 | GRAY OR RED |
| Ochlocknee, GA | 6 | <3 | 9.0 | 80-90 | LIGHT GRAY |
| ATTAPULGITE | 7 | 12 | 1.8 | 75-85 | TAN |
| | 6 | <3 | 1.6 | 80-90 | LIGHT GRAY |
| | 6 | <3 | 0.9 | 80-90 | LIGHT GRAY |
| | 6 | <3 | 0.4 | 80-90 | LIGHT GRAY |
| | 6 | <3 | 0.6 | 80-90 | LIGHT GRAY |
| Taft, CA | 8 | <6 | 5.0 | 75-85 | TAN |
| HYDROUS | 8 | <5 | 1.2 | 75-85 | TAN |
| ALUMINOSILICATE | 8 | <5 | 0.4 | 75-85 | TAN |

TABLE 2
Powders

| | | | | Packed Bulk | | Moisture |
|---|---|---|---|---|---|---|
| Production | | | Alpine Sieve | Density Lbs/Ft³ | pH | Content Wt % |
| Location & Mineral | Product | Process | Ps 006.01.01 | 23-Nf-18-Usp1 | In 001.01.01 | D2216-80 |
| Classification | Name | Options | (GSA) | (USP) | (ODC) | (ODC) |
| Ochlocknee, GA | −325 | RVM | 80% −325 mesh | 43 | 7 | 15 |
| ATTAPULGITE | −325 | LVM | 80% −325 mesh | 38 | 7 | 5 |
| | −325 | ULT | 80% −325 mesh | 37 | 6 | 3 |
| Mounds, IL | −325 | RVM | 80% −325 mesh | 43 | 5 | 10 |
| MONTMORILLONITE | −325 | LVM | 80% −325 mesh | 40 | 5 | 3 |

In 2018, on the SDS sheets for Agsorb® had a 70% SiO₂ guarantee and thought that since it was already sized and designed to be added to blend granular fertilizer, what if we could render the crop required Si from this source?

Verge™ from Oil-Dri has a durable outer core that prevents tiny fragments from breaking off, unlike traditional, irregular-shaped granules that rub together during handling, transportation, and formulation. Verge™ technical specifications are shown in Table 3.

TABLE 3

| | | S | N |
|---|---|---|---|
| | LPHD | Slow | Non- |
| | disintegrating | disintegrating | disintegrating |
| density | 48.5 | 48 | 46 |
| dust index | <0.3 | <0.3 | <0.3 |
| hardness | 94 | 93 | 96 |
| liquid hold capacity | 22 | 23 | 25 |
| moisture | 5 | 6 | 2 |
| pH | 6 | 5 | 5 |
| | SGN 100 | SGN140 | SGN200 |
| mesh size | 16/30 | 12-20 | 8/16 |
| uniformity index | −60 | −60 | −60 |
| angle of repose | 27° | 25° | 25° |
| Granlues per lb. | −900k/lb | −400k/lb | −200k/lb |

U.S. Patent Publication No. 2017/0360029, which is incorporated by reference, discloses a chemical agent for controlling soil nematode. In formulation example 5 uses attapuligite as a carrier.

U.S. Patent Publication No. 2013/0210624 ('624 publication) which is incorporated by reference, discloses granular material employed as a fungicide or a fertilizer or both, comprising phosphorous acid (H₃PO₃) or phosphite (which may include HPO₃), along with a metal and phosphate on a granular carrier; or a mixture of a phosphite product and a phosphate product on a granular carrier; or mixture of a metal phosphite product and phosphate on a granular carrier. The mixture may contain a chelated metal on a granular carrier. Another mixture includes a phosphite product on a first granular carrier, and a phosphate product on a second granular carrier wherein the two are mixed and the phosphite product and the phosphate product may or may not include a metal ion. Alternatively, the mixture may also contain a chelated metal on a third granular carrier.

The '624 publication discloses in paragraph no. [0054] clay-based granules such as that sold by Oil-Dri Corporation as Verge™ may be formulated to disintegrate at an extremely fast rate such as one minute, or to dissolve far more slowly into thousands of micro-particles.

US 2016/0050930 A (published Feb. 5, 2016) to Benfatti et. al. (referenced hereinafter as “BEN”. BEN relates to the a method of controlling insects (in particular insects of the order Hemiptera, especially aphids and whitefly) that are resistant to neonicotinoid insecticides and requires the use of a compound according to formula (1):

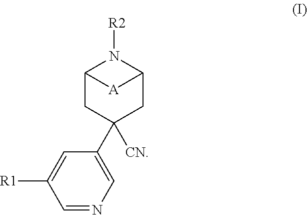

wherein
A is —CH₂—CH₂— or —CH═CH—;
R¹ is halogen; and
R² is hydrogen, formyl, cyano, hydroxy, NH, C₁-C₆ alkyl (optionally substituted by aryl, aryloxy, heteroaryl or hetero-cyclyl, which themselves can be optionally substituted by one to three substituents independently selected from halogen, cyano, nitro, C₁-C₄alkyl, C₁-C₄haloalkyl, and C₁-C₄alkoxy), C₁-C₆ haloalkyl (optionally substituted by one to two substituents independently selected from hydroxy, C₁-C₄-alkoxy, tri(C₁-C₄alkyl)silyloxy, C₁-C₂alkylcarbonyloxy, and C₃-C₅ alkenyl), C₁-C₆ cyanoalkyl, C₁-C₆ alkoxy(C₁-C₆)alkyl (optionally substituted by aryl or heteroaryl, which themselves can be optionally substituted by one to three substituents independently selected from halogen, cyano, nitro, C₁-C₄alkyl, C₁-C₄haloalkyl, and C₁-C₄ alkoxy), C₁-C₄alkoxy(C₁-C₄)alkoxy(C₁-C₄)alkyl, C₁-C₆ alkylcarbonyl(C₁-C₆)alkyl, C₁-C₄ alkoxyimino(C₁-C₄)alkyl, C₁-C₄ haloalkoxy(C₁-C₄)alkyl, C₁-C₆ alkoxycarbonyl(C₁-C₆)alkyl, C₁-C₄ alkoxy(C₁-C₄) alkoxycarbonyl(C₁-C₆)alkyl, hydroxycarbonyl(C₁-C₆)alkyl, aryloxycarbonyl(C₁-C₆)alkyl (wherein the aryl group can be optionally substituted by one or two substituents independently selected from halogen, cyano, nitro, C₁-C₄alkyl, C₁-C₄ haloalkyl, and C₁-C₄ alkoxy), C₁-C₄ alkylaminocarbonyl(C₁-C₆)alkyl, di(C₁-C₄ alkyl)aminocarbonyl(C₁-C₆)alkyl, C₁-C₄haloalkylaminocarbonyl(C₁-C₆)alkyl, di(C₁-C₄ haloalkyl)aminocarbonyl-C₁-C₆ alkyl, C₁-C₂ alkoxy(C₂-C₄)alkylaminocarbonyl(C₁-C₄)alkyl, C₂-C₆ alkenyloxycarbonyl(C₁-C₆) alkyl, C₃-C₆ alkynyloxycarbonyl(C₁-C₆)alkyl, (R³O)₂(O═)P(C₁-C₆)alkyl where R³ is hydrogen, C₁-C₄ alkyl or benzyl, C₃-C₇ cycloalkyl (optionally substituted by one to three substituents independently selected from C₁-C₄ alkyl, C₁-C₄ haloalkyl, and C₁-C₄ alkoxy and, additionally, one of the ring member units can optionally represent C═O or C═NR⁴ where R⁴ is hydrogen, C₁-C₄ alkyl, C₁-C₄ haloalkyl, C₁-C₄ cyanoalkyl, C₁-C₄ alkoxy, or C₃-C₆ cycloalkyl), C₃-C₇ halocycloalkyl, C₃-C₇ cycloalkenyl (optionally substituted by one or two substituents independently selected from C₁-C₄ alkyl, and C₁-C₄ haloalkyl, and, additionally, one of the ring member units can optionally represent C═O), C₃-C₇ halocycloalkenyl, C₁-C₆ alkyl-S(═O)n¹(C₁-C₆)alkyl where n¹ is 0, 1 or 2 (optionally substituted by aryl or heteroaryl or heterocyclyl, which themselves can be optionally substituted by one to three substituents independently selected from halogen, cyano, nitro, C₁-C₄ alkyl, C₁-C₄ haloalkyl, and C₁-C₄ alkoxy), C₃-C₆ alkenyl, C₃-C₆ haloalkenyl, aryl(C₃-C₆)alkenyl, C₃-C₆ alkynyl, C₃-C₆ haloalkynyl, aryl(C₃-C₆)alkynyl, C₃-C₆hydroxyalkynyl, C₁-C₆ alkoxycarbonyl (optionally substituted by one to three substituents independently selected from halogen, hydroxy, cyano, C₁-C₄alkoxy, C₁-C₄haloalkyl, and aryl), aryloxycarbonyl (optionally substituted by one to three substituents independently selected from halogen, cyano, nitro, C₁-C₄alkyl, C₁-C₄haloalkyl, C₁-C₄alkoxy), C₃-C₆ alkenyloxycarbonyl, C₃-C₆alkynyloxycarbonyl, C₁-C₆alkylcarbonyl, C₁-C₆haloalkylcarbonyl, aminocarbonyl, C₁-C₆alkylaminocarbonyl, di(C₁-C₆)alkylaminocarbonyl, aminothiocarbonyl, C₁-C₆alkylaminothiocarbonyl, di(C₁-C₆)alkylaminothiocarbonyl, C₁-C₆alkoxy, C₃-C₆ alkenyloxy, C₃-C₈alkynyloxy, aryloxy (optionally substituted by one to three substituents independently selected from halogen, cyano, nitro, C₁-C₄alkyl, C₁-C₄haloalkyl, and C₁-C₄alkoxy), C₁-C₆alkylamino, di(C₁-C₆)alkylamino, C₃-C₆cycloalkylamino, C₄alkylthio, C₁-C₄alkylsulfinyl, C₁-C₄alkylsulfonyl, C₁-C₄haloalkylsulfonyl, aryl-S(═O)n² (optionally substituted by one or two substituents independently selected from halogen, nitro, and C₁-C₄alkyl) where n² is 0, 1 or 2, aryl (optionally substituted by one to three substituents independently selected from halogen, cyano, nitro, C₁-C₄alkyl, C₁-C₄haloalkyl, C₁-C₄alkoxy, and C₁-C₄haloalkoxy), heteroaryl (optionally substituted by one to three substituents independently selected from halogen, cyano, nitro, C₁-C₄alkyl, C₁-C₄haloalkyl, C₁-C₄alkoxy, and C₁-C₄haloalkoxy), heterocyclyl (optionally substituted by one to three substituents independently selected from halogen, cyano, nitro, C₁-C₄alkyl, C₁-C₄haloalkyl, C₁-C₄alkoxy, and C₁-C₄haloalkoxy, and, additionally, a ring member unit can optionally represent C═O or C═NR⁵ where R⁵ is hydrogen, C₁-C₄ alkyl, C₁-C₄ haloalkyl, C₁-C₄ cyanoalkyl, C₁-C₄ alkoxy, or C₃-C₆ cycloalkyl), (C₁-C₆ alkylthio)carbonyl, (C₁-C₆ alkylthio)thiocarbonyl, C—C alkyl-S(═O)n³ (═NR⁶)—C₁-C₄alkyl wherein R⁶ is hydrogen, cyano, nitro, C₁-C₄alkyl and n³ is 0 or 1, or R² represents a group “—C(R⁷)(R⁸)(R⁹)” wherein R⁷ is C₁-C₄alkyl, C₁-C₄haloalkyl, or cyclopropyl, R⁸ is hydrogen, C₁-C₄alkyl, C₁-C₄haloalkyl, or cyclopropyl, preferably hydrogen, R⁹ is cyano, C₁-C₄alkyl, C₂-C₆ alkenyl, C₂-C₆haloalkenyl, C₁-C₄alkoxy, C₂-C₅ alkynyl, C₂-C₄ alkoxycarbonyl, C₁-C₄ alkylaminocarbonyl, di(C₁-C₃ alkyl)aminocarbonyl, C₁-C₂haloalkylaminocarbonyl, C₃-C₆alkenyloxycarbonyl, C₃-C₄ alkynyloxycarbonyl, or C₁-C₃ alkylcarbonyl; (arylthio)carbonyl(C₁-C₆)alkyl (wherein aryl can be optionally substituted by one to three substituents independently selected from halogen, cyano, nitro, C₁-C₄ alkyl, C₁-C₄ haloalkyl, and C₁-C₄ alkoxy), (C₁-C₃ alkylthio)carbonyl(C₁-C₆)alkyl (optionally substituted by aryl or heteroaryl or heterocyclyl, which themselves can be optionally substituted by one to three substituents independently selected from halogen, cyano, nitro, C₁-C₄ alkyl, C₁-C₄ haloalkyl, and C₁-C₄ alkoxy), or an agrochemically acceptable salt, N-oxide or isomer thereof.

This application is completely different than BEN which is related to insecticides. This application does not require the use of pesticides or insecticides which can be excluded from the invention. BEN is incorporated by reference in its entirety for all useful purposes.

### SUMMARY OF THE INVENTION

It is an object of the invention to find Si source(s), preferably in granular form that could be added to an agriculture composition containing at least one base and can be applied to the ground surface. The agricultural composition can optionally contain a fertilizer, in particular to a granular fertilizer.

Another object is to apply the agriculture composition according to the invention containing the granular Si can be applied in a band or (starter) application, broadcast application or strip placement application. A band or starter application is the placement of the agricultural formation in the same area as the seed. A broadcast application is the general distribution of the agricultural composition over the entire soil surface. A strip placement is the placement of the agricultural composition in narrow strips. Crops will differ with placement and spacing. For example, spacing in sugarcane is 60″ and with multiple applications could be placed about 2″ to about 12″ at plant in the drill or placed on the soil surface with supplement applications after cane has been planted.

The agricultural composition that contains Si source then could be applied at the same time as other fertilizers. It can be applied in one application or multiple applications, such as, but not limited to: 2, 3, 4, 5, 6, etc. applications a year. By applying the agricultural composition would complement the concept of the 4R's, thereby maximizing input efficiencies, get better yields and quality and probably save the grower money.

An object of the invention was to be able to reduce the amount of fertilizer blends used on the fields and to save the grower's time from applying the product. Therefore, there would be less product placed on the fields and this would give the grower more time.

The advantages would be as follows:
The product can travel with all fertilizer blends thereby eliminating the soil amendment of 1-3 tons.
   This opens the door to evaluate for optimum timing and rates of Si for example with sugarcane which is fertilized 2-5 times annually.
   This opens the door to evaluate for optimum placement of Si in conjunction with the growth stage of the crop.
Instead of 1-3 tons per acre, equivalent Si input would only require about 250 to about 750 (respectively) pounds per acre with half the cost.
In conjunction with supplying Si to the crop, when applied at 750 lbs per acre into the planting drill, the absorbent properties of the product would serve to hold moisture around the seed-piece.

Another embodiment of the invention relates to a fertilizer composition comprising a fertilizer and Si clay granules wherein the Si clay granules are in an amount from about 10 to about 90% by weight based on the total amount of the fertilizer and Si clay.

The agricultural composition and the fertilizer composition according to the invention can contain bases such as organic or inorganic bases and materials compatible with same bases.

The bases are preferably but not limited to potassium hydroxide, potassium thio sulfate, ammonium thio sulfate, calcium chloride, potassium carbonate, tri potassium phosphate, di-potassium phosphate, di-potassium phosphyte, fulvic acid, carboxylic acid, humic acid, urea and CORON® which is a controlled-release foliar fertilizer that provides weeks of steady nutrition and trademarked and sold by Helena Agri-Enterprises LLC, Solubor® is manufactured to combine the highest concentration of boron with the maximum possible dispersion and solubility in water and trademarked and sold by Borax and urea.

Either the base source or a combination of the base sources will be applied to the Si source, such as Agsorb, at rates to achieve a target pH of 8-12, but most preferably rates to achieve a target pH of 9-11.

The agricultural composition or fertilizer composition can contain micronutrients and macronutrients as discussed above in the background of the invention section of the application.

The invention also relates to a process of fertilizing a plant which comprises applying the fertilizer to the ground (soil).

The invention also relates to a process of treating a plant which comprises applying the agricultural composition according to the invention to the ground (soil).

An embodiment 1 of the invention is to an agricultural composition which comprises Si clay granules or powders and a base wherein the composition is applied in an amount from about 150 pounds to about 4,000 pounds per acre with the proviso that no insecticides are present in the composition.

Embodiment 2 of the invention is a process of treating a plant which comprises applying an agricultural composition which consisting essentially of Si clay granules or Si clay powders wherein the composition is applied in an amount from about 150 pounds to about 4,000 pounds per acre and said Si clay granules or powders are present in the agricultural composition in an amount from about 10% to about 90% by weight based on the amount of the composition and with the proviso that the composition does not contain a compound of the formula (I)

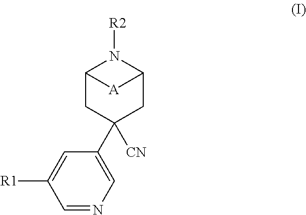

where Embodiment 3—The process as described in embodiment 2, wherein the composition is applied in an amount from about 250 to about 700 pounds per acre.

Embodiment 4—The process as described in embodiments 2 or 3, wherein the base is selected from the group consisting of potassium hydroxide, potassium thio sulfate, ammonium thio sulfate, calcium chloride, potassium carbonate, Tri potassium phosphate, di-potassium phosphate, di-potassium phosphyte, fulvic acid, carboxylic acid, humic acid, CORON®, SOLUBOR® and Urea

Embodiment 5—The process as described in embodiments 2, 3 or 4, wherein the composition further comprises A) a fertilizer,

B) a pH increaser,

C) macronutrients or

D) micronutrients.

Embodiment 6—The process as described in any of the previous process embodiments, wherein the pH increaser is present and is a base.

Embodiment 7—The process as described in any of the previous process embodiments, wherein the macronutrient is present and is nitrogen, phosphorus, potassium, sulfur, calcium, and magnesium.

Embodiment 8—The process as described in any of the previous process embodiments, wherein the micronutrient is present and is a water soluble salt of boron, iron, manganese, magnesium, copper or zinc.

Embodiment 9—The process as described in any of the previous process embodiments, wherein composition is applied to the ground by a band application, broadcast application or strip placement application.

Embodiment 10—The process as described in any of the previous process embodiments, wherein composition is applied within 30 days after the ground has been fertilized.

Embodiment 11—The process as described in any of the previous process embodiments, wherein said Si clay granules or powders are present in the agricultural composition in an amount from about 10% to about 90% by weight based on the amount of the composition.

Embodiment 12—The process as described in any of the previous process embodiments, wherein said Si clay granules or powders are present in the agricultural composition in an amount from about 40% to about 60% by weight based on the amount of the composition.

Embodiment 13—The process as described in any of the previous process embodiments, wherein said Si clay granules or powders are present in the agricultural composition in an amount from about 40% to about 60% by weight based on the amount of the composition.

Embodiment 14—The process as described in any of the previous process embodiments, wherein the Si clay is Attapulgite, Montmorillonite or aluminosilicate or a mixture thereof.

Embodiment 15—The process as described in any of the previous embodiments, wherein the plant is grass crops, turf crops, cucurbit crops, Brassica crops, solanaceae crops, bush berries, citrus, stone fruits, nuts apples, avocado, mangos, lychee or olives.

Embodiment 16—The process as described in any of the previous process embodiments, wherein the plant is barley, maize, oats, rice, rye, sorghum, wheat, millet, sugar cane or bamboo, Bermuda grass, St. Augustine grass, Zoysia grass, Kentucky bluegrass, Perennial ryegrass, pumpkin, squash, zucchini, cucumber, watermelon, gourd, cabbage, cauliflower, broccoli, mustard, brussel sprouts, turnips/turnip greens, collards, kale, bok choy, tomatoes, tomatillos, eggplant, potatoes, goji berries, tobacco, peppers, sugarcane rice, strawberry, blueberry, blackberry, raspberry, mulberry, elderberry, red currants, white currants, black currents, citron, clementine, grapefruit, oranges, sudachi, shonan gold, satsuma, tangelo, tangerine, limetta, tangor, lemons, limes, citron, yuzu or ugli fruit, peaches, nectarines, plums, peanut, almond, apples, avocado, mangos, lychee, olives and ornamental plants.

An embodiment 17 of the invention is to a process of treating a plant which comprises applying an agricultural composition which comprises Si clay granules or powders and a base wherein the composition is applied in an amount from about 150 pounds to about 4,000 pounds per acre and with the proviso that the composition does not contain an insecticide.

An embodiment 18—The process as described in any of the previous process embodiments, wherein Si clay granules or powders are present in the agricultural composition in an amount from about 10% to about 90% by weight based on the amount of the composition.

### A BRIEF DESCRIPTION OF THE FIGURE

FIG. 1 illustrates the results of a laboratory evaluation using the “5 Day Method,” a laboratory method designed to evaluate calcium silicate slag sources and is the standard for comparing dry Si sources. Wollastonite, a natural source of CaSiO3, is known to have high levels of plant available Si and is often used as a standard with regards to Si sources. In this evaluation, the Wollastonite expressed 4.46% plant available Si. The red dotted line is at 0.2% Si and materials that evaluate below this threshold are not worthwhile as a Si source. The base treatment, “AB” expressed % Si levels approaching the Wollastonite. ACA, citric acid treatment; AMn, nitric acid treatment; AUT, untreated.

FIG. 2 illustrates the data according to the invention. As shown, the base option (top line) is 5× the CSS, which is calcium silicate slag.

FIGS. 3 and 4 illustrate the data according to the invention. The reference to first, second, third, fourth fifth and sixth represents the order of sample evaluation shown also in Table 2.

### A DETAILED DESCRIPTION OF THE INVENTION

The invention relates to an agricultural composition comprising Si clay granules and a base which can be applied to the soil in an in an amount from about 150 pounds to about 4,000 pounds per acre, preferably about 250 pounds to about 2,000 pounds per acre and ever more preferably from about 300 pounds to about 750 pounds per acre and most preferably about 400 pounds to about 700 pounds per acre. The agricultural composition can be applied after the soil has been fertilized. Preferably, the first application would be less than 90 days after the soil has been fertilized, preferably less than 60 days, and more preferably less than 30 and most preferably less 15 days. The agricultural composition can be also applied in more than one applications (multiple applications) for the planting cycle. For example, the agricultural composition can be applied in at least 1, 2, 3, 4, 5, 6, 7 or 8 applications.

The agricultural composition contains a base as described above.

The agricultural composition can also contain a fertilizer. The agricultural composition also does not require a fertilizer and exclude a fertilizer.

The invention relates to a fertilizer composition comprising a fertilizer and Si clay granules wherein the Si clay is an amount from about 10 to about 90% by weight based on the total amount of the fertilizer and Si clay.

The fertilizer composition can be used for plants such as, but not limited to grass crops, turf crops, cucurbit crops, Brassica crops, solanaceae crops, bush berries, citrus, stone fruits, nuts, ornamental plants other crops.

Grass crops include but are not limited to barley, maize (corn), oats, rice, rye, sorghum, wheat, millet, sugar cane or bamboo.

Turf crops include but are not limited to Bermuda grass, St. Augustine grass, Zoysia grass, Kentucky bluegrass reed grass, meadow foxtail, pampas grass, sedge, blue fescue, papyrus, fountain grass or Perennial ryegrass.

Cucurbit crops include but are not limited to pumpkin, squash, zucchini, cucumber, watermelon or gourd.

Brassica Crops include but are not limited to cabbage, cauliflower, broccoli, mustard, brussel sprouts, turnips/turnip greens, collards, kale or bok choy.

Solanaceae crops include but are not limited to tomatoes, tomatillos, eggplant, potatoes, goji berries, tobacco, peppers (bell peppers, chili peppers, paprika, tamales, tomatillos, pimentos, cayenne, etc).

Bush berries, such as, but not limited to, strawberry, blueberry, blackberry, raspberry, mulberry, elderberry, red currants, white currants, and black currents.

Citrus, such as, but not limited to, citron, clementine, grapefruit, oranges, sudachi, shonan gold, satsuma, tangelo, tangerine, limetta, tangor, lemons, limes, citron, yuzu or ugli fruit.

Stone fruits, such as, but not limited to peaches, nectarines and plums would also work.

Nuts, such as, but not limited to peanut and almond would also work.

Ornamental plants include but are not limited to rose bushes, tree roses, climbing roses, miniature roses and shrub roses in any color, lilies, tulips, daffodils and onion plants. Japanese maple, along with many other varieties of maple, weeping willow, birch magnolia, pear, cherry, apple and lilac. Conifers which include evergreen trees and shrubs that remain green throughout the season. Weigela, barberry, camellia, lilac maple, dogwood, holly, aromatic herbs such as but not limited to mint, sage, lavender, marigold, thyme, basil and rosemary.

Other crops such as, but not limited to apples, avocado, mangos, lychee and olives.

The fertilizer can be any fertilizer such as a fertilizer containing Nitrogen, Phosphorous and potassium (K) referred to as “NPK” or a fertilizer which does not contain any nitrogen referred to as a XPK. The fertilizer can contain boron, zinc, copper, and iron, blends of nitrogen phosphorous and potash or mixtures thereof.

The fertilizer can be ammonia sulfate, an ammonia salt of a carboxylic acid, mono- or di-potassium phosphate, a micronutrient, ammonia nitrate, urea, ammonia citrate or ammonia acetate.

The Si clay can be any Si clay. The Si clay is preferably, Agsorb® which is granules that include Montmorillonite from Ripley Miss. or from Mounds Ill., Attapulgite from Ochlocknee Ga., Hydrous Aluminosilicate from Taft, Calif. and Verge™ also from Oil-Dri.

Prior to the invention it was known to use a conditioner such as Si clay up to 100 pounds per ton fertilizer. I have found that it is much better to increase the amount of Si clay and it should be in an amount from about 200 to about 1800 pounds to the ton fertilizer. Another words the amount of the Si clay is from about 10% by weight to about 90% by weight, and preferably from 20 to 60% by weight and most preferably 40 to 60% weight of the total weight of fertilizer and Si.

Optional components can be pH increaser and micronutrients.

The composition can contain micronutrients such as, but not limited to a water soluble salt of boron, iron, manganese, magnesium, copper or zinc.

The fertilizer composition according to the invention should be applied to the soil in an amount from about 150 pounds to about 4,000 pounds per acre, preferably about 250 pounds to about 2,000 pounds per acre and ever more preferably from about 300 pounds to about 750 pounds per acre and most preferably about 400 pounds to about 700 pounds per acre.

Sugarcane fertilization requires around 600 pounds of custom fertilizer at planting and 200-300 pounds 3-5 times through the crop cycle (12 months). I was able to incorporate this SiO₂ product with the fertilizer blend in any of these application slots and therefore take advantage of the timing and rate piece of the input strategy.

### Examples

I had the following ingredients mixed as shown in Table 4 below:

TABLE 4

| Ingredients | AB | AMn | ACA | AUT |
|---|---|---|---|---|
| water | 415 | 877 | 1113 | 1965 |
| 0-0-41 | 1480 | 205 | 500 | 0 |
| Mn EDTA | 50 | 883 | 332 | 0 |
| Asset RS | 20 | 20 | 20 | 0 |
| AdSpray 101 | 35 | 35 | 35 | 35 |
| Total pounds | 2000 | 2000 | 2000 | 2000 |

Agricultural silicon (AgSi)=400 pounds treatment+1600 pounds of Agsorb

AB=base (potassium hydroxide); potassium hydroxide and carboxylic acid were mixed into a solution and impregnated to the AgSorb to result in a treated granular product with a pH of 10-11, resulting in AgSi B.

AMn=nitric acid; nitric acid and carboxylic acid were mixed into a solution and impregnated to the AgSorb to result in treated granular product with a pH of 3-4, resulting in AgSi IA.

ACA=citric acid; citric acid and carboxylic acid were mixed into a solution and impregnated to the AgSorb to result in treated granular product with a pH of 3-4, resulting in AgSi OA.

AUT=untreated.

Field trials (data) clearly suggest that the plant tissue silicon levels track similarly in sugarcane with either calcium silicate slag (grower standard) at 3 tons per acre, or AgSi, an acid treated montmorillonite or attapulgite granule, at 750 pounds per acre. Even so, when evaluated with the most accepted method determining plant available Si, (SiO2), in dry products, the “5 Day Method” renders results inconsistent with the field trials.

The field trial data is shown in the Figure.

Wollastonite=standard;

The AgSi treated with KOH extracted levels of Si similar to the Wollastonite (see FIG. 1).

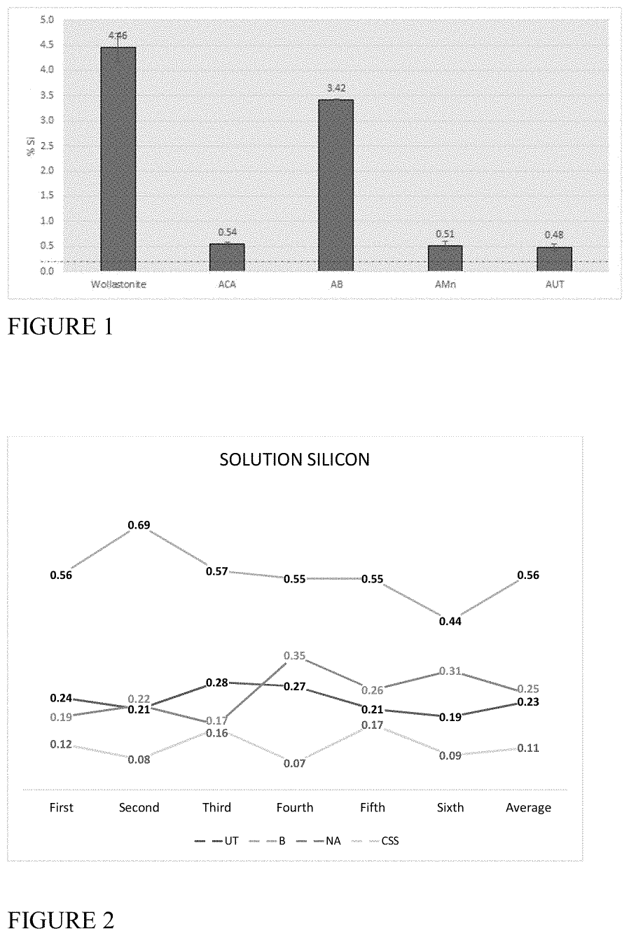

The procedure of the Dis-solution Trial (DSS) trial was to take 50 grams of the treated material and add 200 ml of distilled water and allow hydrolysis to act upon the material over time with agitation. As a part of the procedure, all treatments were shaken regularly and consistently across several days between samples. All samples treated the same. Solution samples (50 ml) were drawn from the clear solution part of the treatment for evaluation, then replaced with 50 ml of distilled water in order to initiate the next step of the DSS. This is shown in FIG. 2.

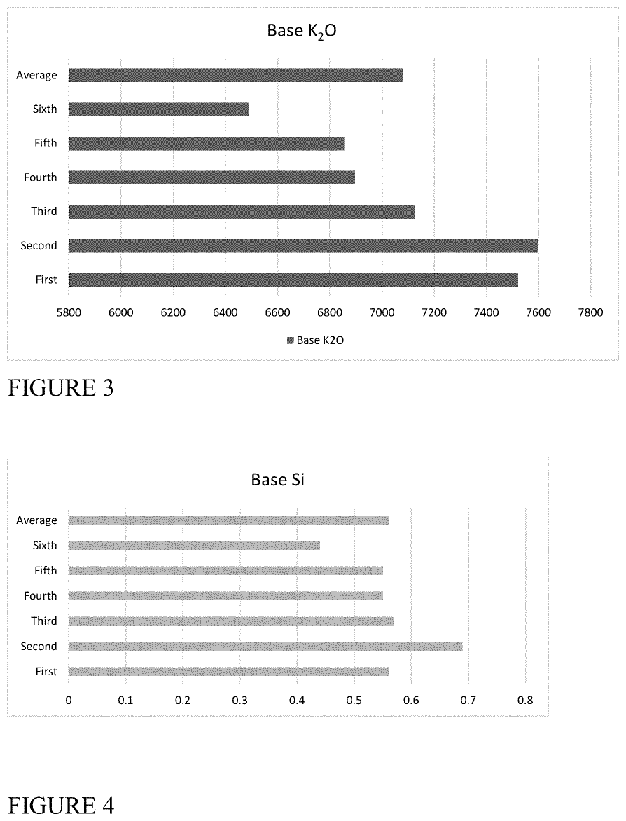

As shown in FIGS. 2-4, the reference to first, second, third, fourth fifth and sixth represents the order of sample evaluation. Samples were evaluated for SiO2 (available Silicon), pH, Manganese and Potassium. There are four treatments, untreated (UT), base (B), nitric acid (NA) and calcium silicate slag (CSS), which is the grower standard.

All treatments were significantly higher than the (CSS), with the (B) results average 5 times the extracted Si from the grower standard (CSS).

It is important to note that the base source has potassium derived from potassium hydroxide. Not only does this source in the planting environment serve to release available Si from the AgSorb granule, but also serve to map the effect of the treatment on the Ag Sorb granule with respect to Si release, (which is the primary component of AgSorb, 70.8% SiO2). Potassium is not present in raw AgSorb from Georgia. So when considering these FIGS. 2-4, the trend of the release of Si to mirror the release of K₂O, indicating the base treatment serves to render available Si from a source thought not to have available (Si).

All ranges disclosed herein are inclusive of the endpoints, and the endpoints are independently combinable with each other (e.g., ranges of “10% to 90%, is inclusive of the endpoints and all intermediate values of the ranges of “10 to 90” etc.). Again, when ranges are listed in the specification and in the claims, it is understood that all the numbers including decimals within the range are included whether specifically disclosed. For example, if the range is from 1 to 10, the range would include every number within the range, such as 1; 1.1; 1.2; 1.3; 1.4; 1.5; 1.6; 1.7; 1.8; 1.9; 2; 2.1; 2.2; 2.3; 2.4; 2.5; 2.6; 2.7; 2.8; 2.9; 3; 3.1; 3.2; 3.3; 3.4; 3.5; 3.6; 3.7; 3.8; 3.9; 4; 4.1; 4.2; 4.3; 4.4; 4.5; 4.6; 4.7; 4.8; 4.9; 5; 5.1; 5.2; 5.3; 5.4; 5.5; 5.6; 5.7; 5.8; 5.9; 6; 6.1; 6.2; 6.3; 6.4; 6.5; 6.6; 6.7; 6.8; 6.9; 7; 7.1; 7.2; 7.3; 7.4; 7.5; 7.6; 7.7; 7.8; 7.9; 8; 8.1; 8.2; 8.3; 8.4; 8.5; 8.6; 8.7; 8.8; 8.9; 9; 9.1; 9.2; 9.3; 9.4; 9.5; 9.6; 9.7; 9.8; 9.9 and 10.

“Combination” is inclusive of blends, mixtures, alloys, reaction products, and the like. The terms “a” and “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the film(s) includes one or more films). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

All the references described above are incorporated by reference for all useful purposes.

I claim:

1. An agricultural composition comprising Si clay granules or Si clay powders and a base wherein the composition would be applied in an amount from about 150 pounds to about 4,000 pounds per acre and with the proviso composition does not contain an insecticide.

2. A process of treating a plant which comprises applying an agricultural composition which consisting essentially of Si clay granules or Si clay powders wherein the composition is applied in an amount from about 150 pounds to about 4,000 pounds per acre and said Si clay granules or powders are present in the agricultural composition in an amount from about 10% to about 90% by weight based on the amount of the composition and with the proviso that the composition does not contain a compound of the formula (I) 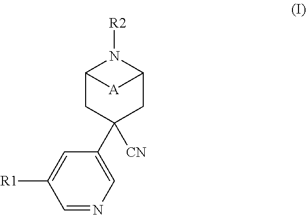
wherein,
A is —CH₂—CH₂— or —CH═CH—;
R¹ is halogen; and
R² is hydrogen, formyl, cyano, hydroxy, NH, C₁-C₆ alkyl (optionally substituted by aryl, aryloxy, heteroaryl or hetero-cyclyl, which themselves can be optionally substituted by one to three substituents independently selected from halogen, cyano, nitro, C₁-C₄ alkyl, C₁-C₄ haloalkyl, and C₁-C₄ alkoxy), C₁-C₆ haloalkyl (optionally substituted by one to two substituents independently selected from hydroxy, C₁-C₄-alkoxy, tri(C₁-C₄ alkyl)silyloxy C₁-C₂ alkylcarbonyloxy, and C₃-C₅ alkenyl), C₁-C₆ cyanoalkyl, C₁-C₆ alkoxy(C₁-C₆) alkyl (optionally substituted by aryl or heteroaryl, which themselves can be optionally substituted by one to three substituents independently selected from halogen, cyano, nitro, C₁-C₄alkyl, C₁-C₄haloalkyl, and C₁-C₄ alkoxy), C₁-C₄ alkoxy(C₁-C₄)alkoxy(C₁-C₄)alkyl, C₁-C₆ alkylcarbonyl(C₁-C₆)alkyl, C₁-C₄ alkoxyimino(C₁-C₄)alkyl, C₁-C₄ haloalkoxy(C₁-C₄)alkyl, C₁-C₆ alkoxycarbonyl(C₁-C₆)alkyl, C₁-C₄ alkoxy(C₁-C₄) alkoxycarbonyl(C₁-C₆)alkyl, hydroxycarbonyl(C₁-C₆)alkyl, aryloxycarbonyl(C₁-C₆)alkyl (wherein the aryl group can be optionally substituted by one or two substituents independently selected from halogen, cyano, nitro, C₁-C₄alkyl, C₁-C₄ haloalkyl, and C₁-C₄ alkoxy), C₁-C₄ alkylaminocarbonyl(C₁-C₆)alkyl, di(C₁-C₄ alkyl)aminocarbonyl(C₁-C₆)alkyl, C₁-C₄haloalkylaminocarbonyl(C₁-C₆)alkyl, di(C₁-C₄ haloalkyl)aminocarbonyl-C₁-C₆ alkyl, C₁-C₂ alkoxy(C₂-C₄)alkylaminocarbonyl(C₁-C₄)alkyl, C₂-C₆ alkenyloxycarbonyl (C₁-C₆) alkyl, C₃-C₆ alkynyloxycarbonyl(C₁-C₆)alkyl, (R³O)₂(O═)P(C₁-C₆)alkyl where R³ is hydrogen, C₁-C₄ alkyl or benzyl, C₃-C₇ cycloalkyl (optionally substituted by one to three substituents independently selected from C₁-C₄ alkyl, C₁-C₄ haloalkyl, and C₁-C₄ alkoxy and, additionally, one of the ring member units can optionally represent C═O or C═NR⁴ where R⁴ is hydrogen, C₁-C₄ alkyl, C₁-C₄ haloalkyl, C₁-C₄ cyanoalkyl, C₁-C₄ alkoxy, or C₃-C₆ cycloalkyl), C₃-C₇ halocycloalkyl, C₃-C₇ cycloalkenyl (optionally substituted by one or two substituents independently selected from C₁-C₄ alkyl, and C₁-C₄ haloalkyl, and, additionally, one of the ring member units can optionally represent C═O), C₃-C₇ halocycloalkenyl, C₁-C₆ alkyl-S(═O)n¹(C₁-C₆)alkyl where n¹ is 0, 1 or 2 (optionally substituted by aryl or heteroaryl or heterocyclyl, which themselves can be optionally substituted by one to three substituents independently selected from halogen, cyano, nitro, C₁-C₄ alkyl, C₁-C₄ haloalkyl, and C₁-C₄ alkoxy), C₃-C₆ alkenyl, C₃-C₆ haloalkenyl, aryl(C₃-C₆)alkenyl, C₃-C₆ alkynyl, C₃-C₆ haloalkynyl, aryl(C₃-C₆)alkynyl, C₃-C₆hydroxyalkynyl, C₁-C₆ alkoxycarbonyl (optionally substituted by one to three substituents independently selected from halogen, hydroxy, cyano, C₁-C₄alkoxy, C₁-C₄haloalkyl, and aryl), aryloxycarbonyl (optionally substituted by one to three substituents independently selected from halogen, cyano, nitro, C₁-C₄alkyl, C₁-C₄haloalkyl, C₁-C₄alkoxy), C₃-C₆ alkenyloxycarbonyl, C₃-C₆alkynyloxycarbonyl, C₁-C₆alkylcarbonyl, C₁-C₆haloalkylcarbonyl, aminocarbonyl, C₁-C₆alkylaminocarbonyl, di(C₁-C₆)alkylaminocarbonyl, aminothiocarbonyl, C₁-C₆alkylaminothiocarbonyl, di(C₁-C₆)alkylaminothiocarbonyl, C₁-C₆alkoxy, C₃-C₆ alkenyloxy, C₃-C₈alkynyloxy, aryloxy (optionally substituted by one to three substituents independently selected from halogen, cyano, nitro, C₁-C₄alkyl, C₁-C₄haloalkyl, and C₁-C₄alkoxy), C₁-C₆alkylamino, di(C₁-C₆)alkylamino, C₃-C₆cycloalkylamino, C₁-C₄alkylthio, C₁-C₄alkylsulfinyl, C₁-C₄alkylsulfonyl, C₁-C₄haloalkylsulfonyl, aryl-S(═O)n² (optionally substituted by one or two substituents independently selected from halogen, nitro, and C₁-C₄alkyl) where n² is 0, 1 or 2, aryl (optionally substituted by one to three substituents independently selected from halogen, cyano, nitro, C₁-C₄alkyl, C₁-C₄haloalkyl, C₁-C₄alkoxy, and C₁-C₄haloalkoxy), heteroaryl (optionally substituted by one to three substituents independently selected from halogen, cyano, nitro, C₁-C₄alkyl, C₁-C₄haloalkyl, C₁-C₄alkoxy, and C₁-C₄haloalkoxy), heterocyclyl (optionally substituted by one to three substituents independently selected from halogen, cyano, nitro, C₁-C₄alkyl, C₁-C₄haloalkyl, C₁-C₄alkoxy, and C₁-C₄haloalkoxy, and, additionally, a ring member unit can optionally represent C═O or C═NR⁵ where R⁵ is hydrogen, C₁-C₄ alkyl, C₁-C₄ haloalkyl, C₁-C₄ cyanoalkyl, C₁-C₄ alkoxy, or C₃-C₆ cycloalkyl), (C₁-C₆ alkylthio)carbonyl, (C₁-C₆ alkylthio)thiocarbonyl, C—C alkyl-S(═O)n³ (═NR⁶)—C₁-C₄alkyl wherein R⁶ is hydrogen, cyano, nitro, C₁-C₄alkyl and n³ is 0 or 1, or R² represents a group “—C(R⁷)(R⁸)(R⁹)” wherein R⁷ is C₁-C₄alkyl, C₁-C₄haloalkyl, or cyclopropyl, R⁸ is hydrogen, C₁-C₄alkyl, C₁-C₄haloalkyl, or cyclopropyl, preferably hydrogen, R⁹ is cyano, C₁-C₄alkyl, C₂-C₆ alkenyl, C₂-C₆haloalkenyl, C₁-C₄alkoxy, C₂-C₅ alkynyl, C₂-C₄alkoxycarbonyl, C₁-C₄alkylaminocarbonyl, di(C₁-C₃ alkyl)aminocarbonyl, C₁-C₂haloalkylaminocarbonyl, C₃-C₆alkenyloxycarbonyl, C₃-C₄ alkynyloxycarbonyl, or C₁-C₃ alkylcarbonyl; (arylthio)carbonyl(C₁-C₆)alkyl(wherein aryl can be optionally substituted by one to three substituents independently selected from halogen, cyano, nitro, C₁-C₄ alkyl, C₁-C₄ haloalkyl, and C₁-C₄ alkoxy), (C₁-C₃ alkylthio) carbonyl (C₁-C₆) alkyl (optionally substituted by aryl or heteroaryl or heterocyclyl, which themselves can be optionally substituted by one to three substituents indepen-dently selected from halogen, cyano, nitro, C₁-C₄ alkyl, C₁-C₄ haloalkyl, and C₁-C₄ alkoxy), or an agrochemically acceptable salt, N-oxide or isomer thereof.

3. The process as claimed in claim 2, wherein the composition is applied in an amount from about 250 to about 2000 pounds per acre.

4. The process as claimed in claim 2, wherein the composition is applied in an amount from about 250 to about 700 pounds per acre.

5. The process as claimed in claim 2, wherein the base is selected from the group consisting of potassium hydroxide, potassium thio sulfate, ammonium thio sulfate, calcium chloride, potassium carbonate, Tri potassium phosphate, di-potassium phosphate, di-potassium phosphyte, fulvic acid, carboxylic acid, humic acid, CORON®, SOLUBOR® and Urea.

6. The process as claimed in claim 2, wherein the composition further comprises
A) a fertilizer,
B) a pH increaser,
C) macronutrients or
D) micronutrients.

7. The process as claimed in claim 2, wherein the pH increaser is present.

8. The process as claimed in claim 2, wherein the macronutrient is present and is nitrogen, phosphorus, potassium, sulfur, calcium, and magnesium.

9. The process as claimed in claim 2, wherein the micronutrient is present and is a water soluble salt of boron, iron, manganese, magnesium, copper or zinc.

10. The process as claimed in claim 2, wherein composition is applied to the ground by a band application, broadcast application or strip placement application.

11. The process as claimed in claim 2, wherein composition is applied within 30 days after the ground has been fertilized.

12. The process as claimed in claim 2, wherein said Si clay granules or powders are present in the agricultural composition in an amount from about 10% to about 90% by weight based on the amount of the composition.

13. The process as claimed in claim 2, wherein said Si clay granules or powders are present in the agricultural composition in an amount from about 40% to about 60% by weight based on the amount of the composition.

14. The process as claimed in claim 2, wherein said Si clay granules or powders are present in the agricultural composition in an amount from about 40% to about 60% by weight based on the amount of the composition.

15. The process as claimed in claim 2, wherein the Si clay is attapulgite, montmorillonite or aluminosilicate or a mixture thereof.

16. The process as claimed in claim 2, wherein the plant is grass crops, turf crops, cucurbit crops, Brassica crops, solanaceae crops, bush berries, citrus, stone fruits, nuts, ornamental crops, apples, avocado, mangos, lychee or olives.

17. A process of treating a plant which comprises applying an agricultural composition which consisting essentially of Si clay granules or Si clay powders wherein the composition is applied in an amount from about 150 pounds to about 4,000 pounds per acre and with the proviso that the composition does not contain an insecticide.

18. The process as claimed in claim 2, wherein Si clay granules or powders are present in the agricultural composition in an amount from about 10% to about 90% by weight based on the amount of the composition.
